(19) United States
(12) Patent Application Publication
(10) Pub. No.: US 2013/0152076 A1
(43) Pub. Date: Jun. 13, 2013

(54) Network Access Control Policy for Virtual Machine Migration

(71) Applicant: Alpesh Patel, Cary, NC (US)

(72) Inventor: Alpesh Patel, Cary, NC (US)

(73) Assignee: Cisco Technology, Inc., San Jose, CA (US)

(21) Appl. No.: 13/313,663

(22) Filed: Dec. 7, 2011

(51) Int. Cl. G06F 9/455; G06F 15/16

(52) U.S. Cl. 718/1

(57) ABSTRACT

Techniques are provided to apply a network access control policy to a virtual machine (VM) migration before allowing the VM to migrate from one server to another server. At a first device in a network, a message is received from a second device, the message comprising information configured to request a migration of a virtual machine to the first device. A request is sent to the second device configured to request information about the operating conditions of the VM. A response to the request is received comprising information about the VM's operating conditions. A determination is made as to whether the information in the response complies with a network access control policy. In response to determining that the information complies with the network access control policy, the virtual machine is permitted to migrate, or otherwise the virtual machine migration request is denied.

### TECHNICAL FIELD

The present disclosure relates to virtual machine migration.

### BACKGROUND

Data centers may host applications and store large amounts of data for an organization or multiple organizations. An enterprise data center or “cloud” may be privately owned and discreetly provide services for a number of customers, with each customer using data center resources by way of private networks, e.g., virtual private networks (VPNs).

Enterprise data centers may occasionally run out of capacity or other resources. When this occurs, the enterprise data center may lease excess capacity, i.e., cloud capacity, from a provider or public data center and migrate services to the public data center over a public network, e.g., the Internet. By sharing resources among data centers, each data center saves money by not having to build out hardware infrastructure to a maximum capacity. The provided services may be in the form of applications or servers, e.g., a web server, operating as virtual machines (VMs). When private data center resources become available, the VMs may migrate from the public data center back to the private data center. VM migration, however, brings with it the possibility of computer virus and related security issues.

### BRIEF DESCRIPTION OF THE DRAWINGS

FIG. 1 is an example of a block diagram of a network with two data centers coupled by a Wide Area Network (WAN), where servers in the data centers are configured to apply network access control (NAC) policies to VMs before VM migration.

FIG. 2a is an example of a block diagram of relevant portions of the network from FIG. 1 together with a ladder diagram illustrating a NAC policy process for VM migration from a private network to a public network according to the techniques described herein.

FIG. 2b shows the network from FIG. 1 with a ladder diagram illustrating the NAC policy process for VM migration from the public network back to the private network according to the techniques described herein.

FIG. 3 is an example hardware block diagram of a network device, e.g., a server, configured to apply a NAC policy to VM migration.

FIG. 4a depicts a flowchart of a process for applying a NAC policy to VMs at the receiving server before migration.

FIG. 4b depicts a flowchart of a process for applying a NAC policy to VMs at the sending server before migration.

### DESCRIPTION OF EXAMPLE EMBODIMENTS

### Overview

Techniques are provided herein to apply a network access control policy to a virtual machine (VM) migration before allowing the VM to migrate from one server to another server. At a first device in a network, a message is received from a second device, the message comprising information configured to request a migration of a virtual machine to the first device. A request is sent to the second device configured to request information about the operating conditions of the VM. A response to the request is received comprising information about the VM's operating conditions. A determination is made as to whether the information in the response complies with a network access control policy. In response to determining that the information complies with the network access control policy, the virtual machine is permitted to migrate, or otherwise the virtual machine migration request is denied.

Conversely, a message is sent to a first device in a network from a second device, where the message requests the migration of a VM to the first device. A request message is received from the first device, where the message is configured to request information about the operating conditions of the VM. A response to the request message is sent comprising information about the VM's operating conditions. A message is received from the first device granting or denying the VM migration request. In response to receiving a grant message, the virtual machine is migrated; otherwise the virtual machine migration to the first device is canceled or denied.

### Example Embodiments

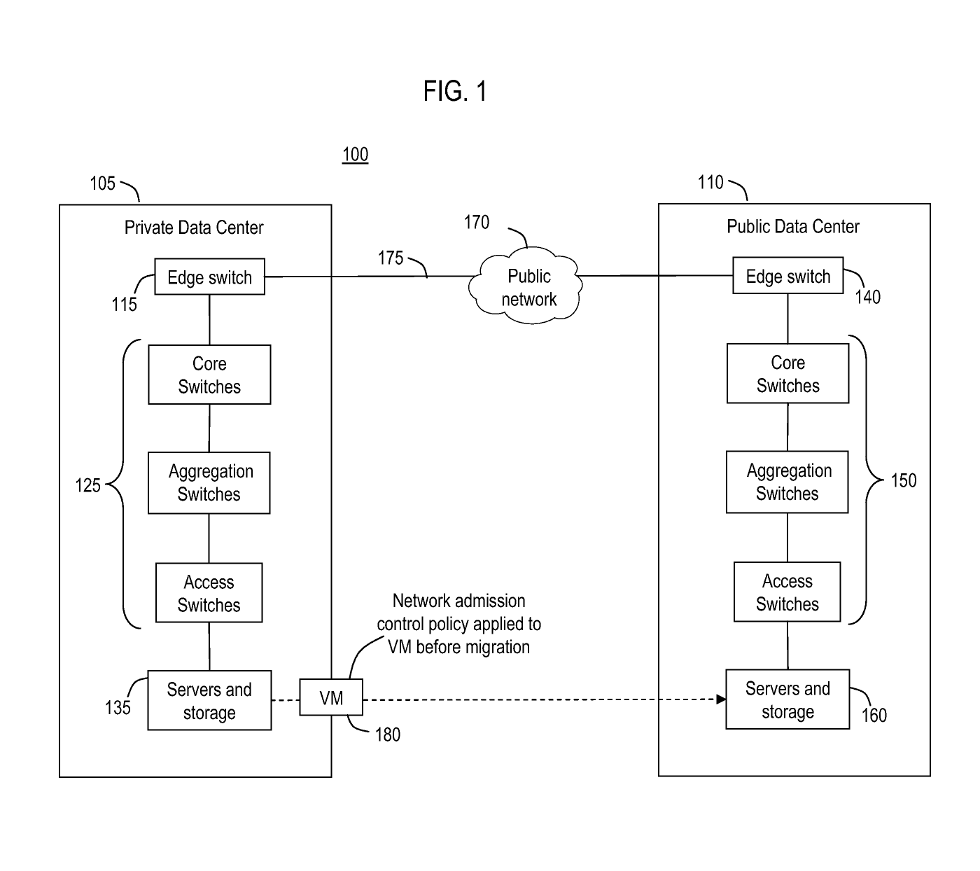

Referring first to FIG. 1, an example system 100 is shown for a multiple data center environment. System 100 comprises a private data center 105 and a public data center 110. The two data centers 105 and 110 communicate with each other using edge switches 115 and 140, respectively, by way of interconnect links 175 over public network 170. The data centers 105 and 110 comprise a plurality of servers and storage devices 135 and 160. The servers, e.g., blade servers, may host application services, e.g., World Wide Web server applications or remotely hosted VM applications. The storage devices may be part of a Storage Area Network (SAN).

Each of the data centers 105 and 110 comprise access switches, aggregation switches and access switches collective shown at reference numerals 125 and 150, respectively, to aggregate and distribute ingress(upstream traffic), and egress (downstream traffic). A plurality of switches is provided at each access, aggregation, and core level to achieve redundancy within the data centers 105 and 110. In this example, a single VM 180 is positioned for VM migration from data center 105 to data center 110. The migration of VM 180 may be triggered by operation constraints, e.g., server overload, in data center 105, and data center 110 is initially deemed to have enough processing, memory, and network throughput capacity to accommodate operations of VM 180.

Typically, VM migration is performed at the data link layer, i.e., Layer 2 of the Open Systems Interconnect (OSI) model, for inter-cloud computing operations. For example, Internet Protocol (IP) encapsulation of Ethernet traffic for IP tunneling over the public network 170 may be used, e.g., such as through the use of Ethernet over Multiprotocol Label Switching (EoMPLS). When VM 180 is part of a local area network (LAN) and migrates between data centers, the LAN is connected by LAN extension through a wide area network (WAN) or public network 170, e.g., the Internet, as part of a Layer 3 VPN. LAN extension is a technology that allows these LAN entities in different data centers to “talk” to each other by treating the underlying network as a single LAN.

Prior to performing the VM migration, the VM 180 is subject to a Network Access Control (NAC) policy, also referred to as a Network Admission Control policy according to the techniques described herein. Traditionally, NAC is a computer networking solution that uses a set of protocols to define and implement a policy that describes how to secure access to network nodes by devices when they initially attempt to access the network. NAC may integrate an automatic remediation process, e.g., fixing non-compliant nodes, before allowing access into the network. The network infrastructure such as routers, switches, and firewalls work together with data center servers and the end user computing equipment to ensure the network is operating securely before interoperability is allowed. NAC controls access to a network with policies, including pre-admission security policy checks and post-admission controls. NAC may limit user device access and user device permissions. In a primitive form, the IEEE 802.1X standard, a port-based NAC protocol, was an initial form of NAC.

In a data center environment, with VMs migrating between data centers and between servers in a data center, the possibility of VM contamination, e.g., by a virus or worm, is an ever present danger. Furthermore, when VMs migrate between data centers, each data center may have its own access control policy and its own service capabilities, i.e., the governing/administrative rules may be different between enterprise and provider clouds, and the enterprise or provider may have more stringent policies to limit or prevent issues like virus or worm propagation to its customers.

In the example shown in FIG. 1, the migration of VM 180 from servers and storage 135 to 160 is logically represented by the dashed line between data centers 105 and 110. It should be understood that the actual migration occurs over network 170 by way of the switches in the data canters 105 and 110. In this regard, the NAC policies may be applied, e.g., at the servers 135 or 160, edge switches 115 and 140, or at any firewalls or other network appliances in the respective data centers 105 or 110.

Prior to any VM migration from one device to another, either within the data center or between data centers, the device receiving the VM has to sufficient capacity, e.g., the memory, processing resources, and network bandwidth to accept the VM. This capacity check is performed for every VM migration. The NAC techniques described herein provide an additional VM migration check, i.e. the NAC techniques provide a security check. This security check is optional and may be performed before or after the capacity check.

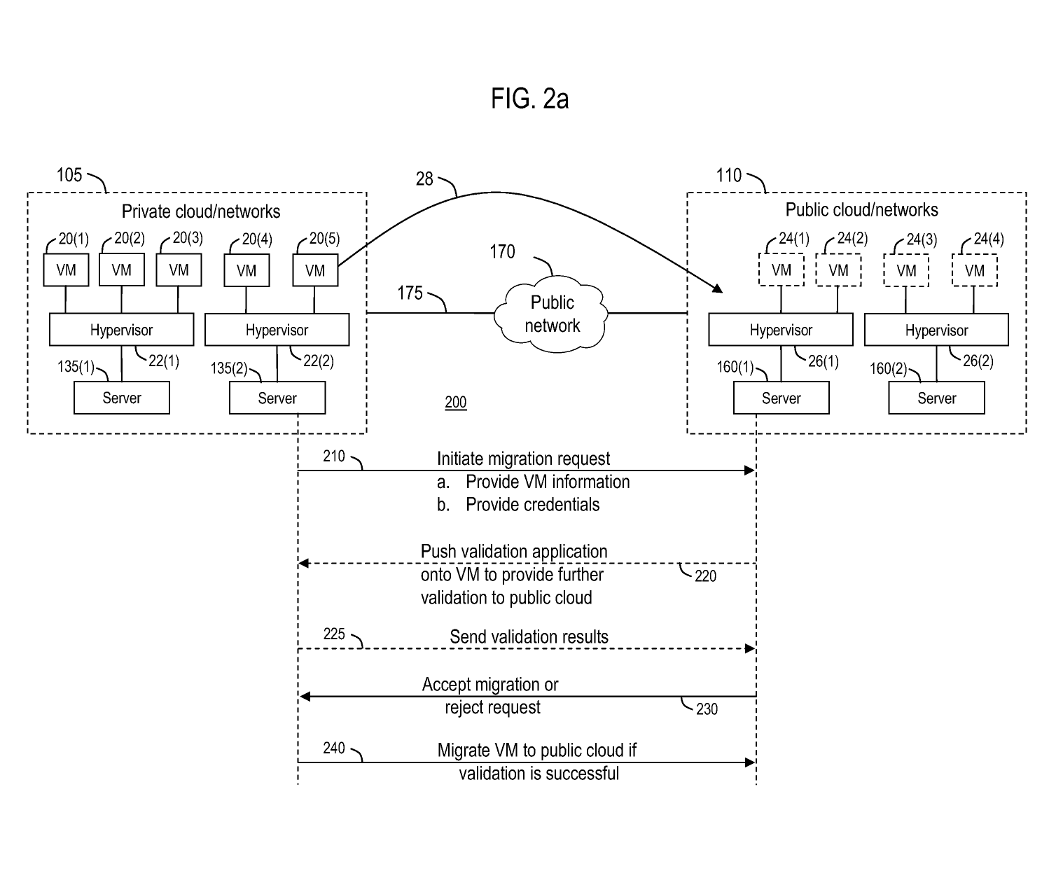

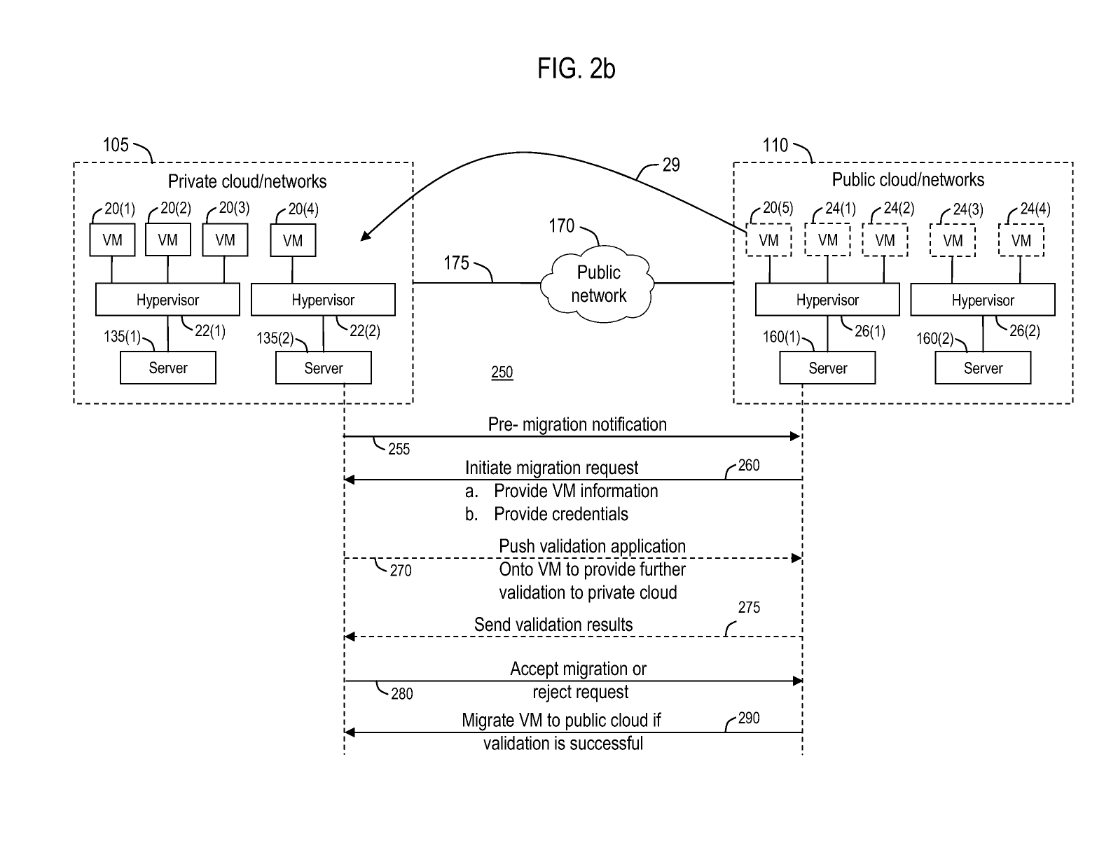

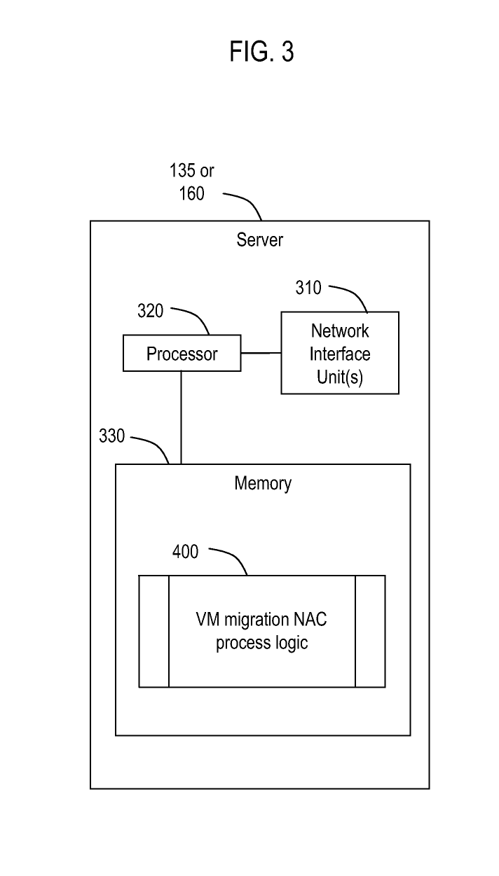

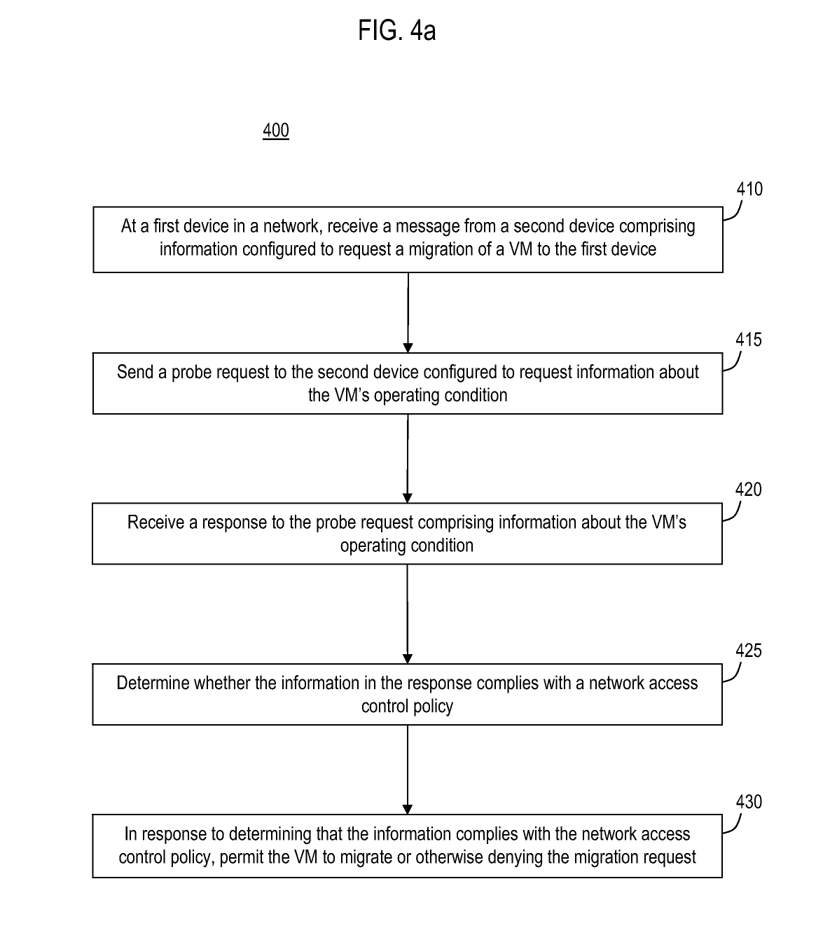

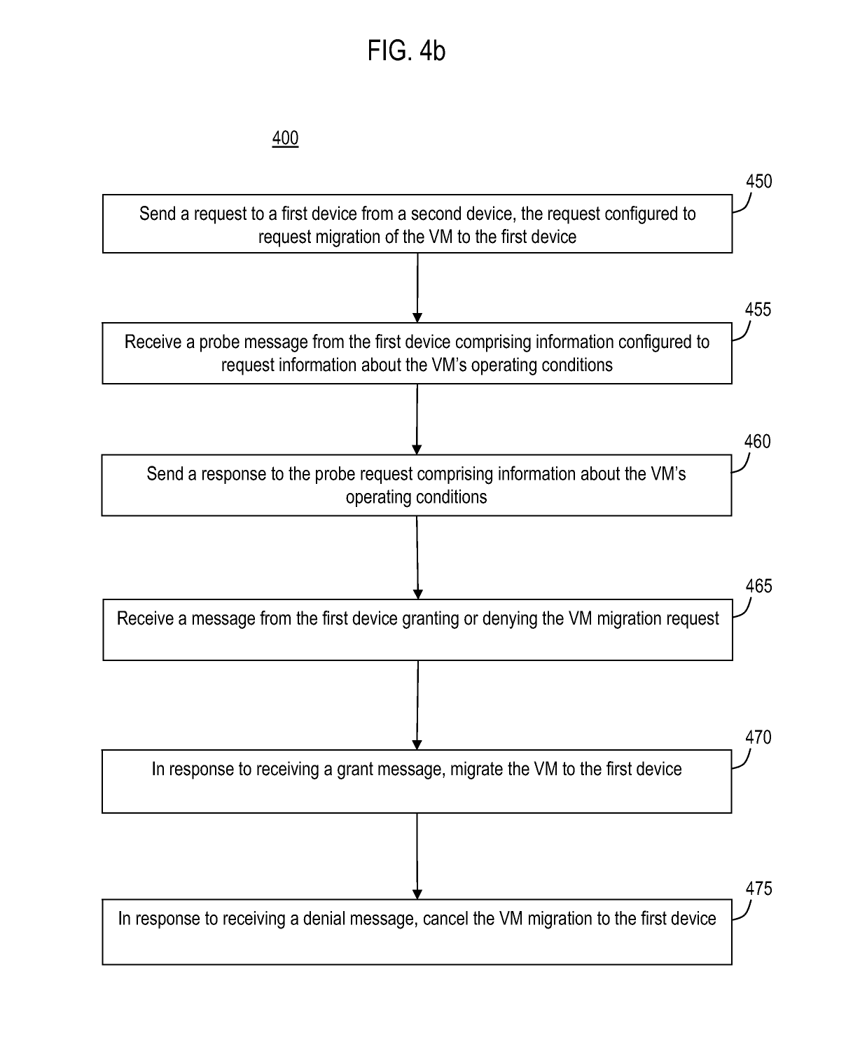

According to the techniques described herein, NAC policies can be applied on a per VM basis in a global and automated fashion prior to migration, i.e., a posture validation may be performed on migrating VMs. Briefly, after receiving a migration request, a server to which the VM is to be migrated (referred to herein as the “receiving server”) queries the sending server (the server from which the VM is to be migrated) for the VM's operating parameters, e.g., VM ports, applications, traffic load, etc. In addition, the receiving data center or server may provide a “trusted” agent that runs in connection with the VM on the sending server prior to migration. The trusted agent is a software process that determines or assists in determining if VM migration is appropriate for the server-to-server or data center-to-data center migration. The process for performing NAC prior to VM migration is performed by VM migration NAC process logic described further herein. Specific examples of the process will described in connection with FIGS. 2a and 2b, described generally in connection with FIG. 3 and in greater detail in connection with FIGS. 4a and 4b.

When VM migrations are rejected, the enterprise and provider operators can work to fix interoperability issues, e.g., based on service level agreement (SLAs), mutual trust authentication, and by manual intervention.

The term “posture”, as mentioned above, may be used to refer to the collection of attributes that play a role in the conduct and “health” of the VM that is seeking access to another network, e.g., VM 20(5) seeing access to public data center 110. Some of the attributes relate to the VM's operating system or other attributes that pertain to various applications that might be operating on the endpoint, such as antivirus (AV) scanning software. Posture validation, or posture assessment, refers to the act of applying a set of rules to the posture data to provide an assessment (posture token) of the level of trust that can be placed in that VM. The posture token is one of the conditions in the authorization rules for network access. Accordingly, posture validation in the context of VM migration, provides a security assessment of the VM to the receiving network.

Referring to FIG. 2a, an example of a block diagram of relevant portions of the network from FIG. 1 coupled with a ladder diagram 200 is shown that illustrates the VM migration NAC process for VM migration from a private network to a public network according to the techniques describe herein. The relevant portions of data centers 105 and 110 are shown as indicated by the dashed boxes, as well as public network 170 and the connection links 175. Two of the servers 135(1) and 135(2) from data center 105 are shown along with two of the servers 160(1) and 160(2) from data center 110.

The servers 135(1), 135(2), 160(1) and 160(2) are shown along with their associated hypervisors 22(1), 22(2), 26(1), and 26(2), respectively. Hypervisors 22(1) and 22(2) support a plurality of VMs 20(1)-20(5). VMs 20(1)-20(5) may provide one or more private networks in a private cloud. Similarly, hypervisors 26(1) and 26(2) support a plurality of VMs 24(1)-24(4). VMs 24(1)-24(4) have been previously migrated from one or more private networks as indicated by the dashed boxes. Hypervisors are hardware abstraction layers that provide operating system independence for applications and services provided by VMs. In this example, VM 20(5) is targeted for migration shown at reference numeral 28 from the private cloud/data center 105 to the public cloud/data center 110, e.g., due to conditions experienced in the private cloud.

The ladder diagram 200 in FIG. 2a is now described. At 210, VM migration is initiated by server 135(2) for VM 20(5) to migrate from server 135(2) to server 160(1). As part of the migration, server 135(2) provides VM operating information as described above and migration credentials for the VM, e.g., VM 20(5). At this point, since there is a trusted relationship between the enterprise and provider clouds, the server 160(1) may accept the VM credentials and determine if migration is acceptable based on whether the private cloud can support the operating conditions with respect to VM 20(5).

If additional validation information is needed, optionally at 220, a validation application, e.g., a trusted agent, is pushed onto VM 20(5) to provide further validation to the public cloud. The validation application runs in conjunction with the VM and collects information about the operating conditions of the VM, and may also repair the VM if the VM is operationally deficient as will be described below. At 225, the validation results are returned to the receiving server 160(1). Pushing a validation application and returning validation results are optional as indicated by the dashed lines at 220 and 225. At 230, the VM migration is either accepted or rejected based on either the credentials received at 210 or the validation results received at 225. At 240, if the validation is successful and accepted by server 160(1), then VM 20(5) is migrated from server 135(2) to server 160(1).

Referring to FIG. 2b, an example of a block diagram similar to that of FIG. 2a is shown, together with a ladder diagram 250, to illustrate the VM migration NAC process for VM migration from public data center 110 to private data center 105 according to the techniques describe herein. At this point, conditions in data center 105 or resources allocated to a tenant operating VM 20(5) now permit VM 20(5) to return from the public data center 110 to the private data center 105. Accordingly, VM 20(5) is targeted for VM migration 29.

Turning to the ladder diagram 250, at 255, a pre-migration notification or other communication is issued by server 135(2) to request that VM 20(5) be migrated back to data center 105. At 260, VM migration is initiated by server 160(1) for VM 20(5) to migrate from server 160(1) to 135(2). As part of the migration, server 135(2) provides VM operating information and migration credentials for the VM 20(5). At this point, since there is a trusted relationship between the enterprise and provider clouds, the server 160(1) may accept the VM credentials and determine if migration is acceptable based on whether the private cloud can support the operating conditions with respect to VM 20(5).

If additional validation information is needed, optionally at 270, a validation application is pushed onto VM 20(5) to provide further validation to the private cloud. At 275, the validation results are returned to the receiving server 135(2). At 280, the VM migration is either accepted or rejected based on either the credentials received at 260 or the validation results received at 275. At 290, if the validation is successful and accepted by server 135(2), then VM 20(5) is migrated from server 160(1) to server 135(2).

Turning now to FIG. 3, an example block diagram of a network appliance or server, e.g., one of servers 135 or 160 is shown. For ease of illustration the network appliance will be referred to as server 135 in the description of FIG. 3. The server 135 comprises one or more network interface units 310, a processor 320 and a memory 330 storing VM migration NAC process logic 400. The network interface unit 310 is coupled to the processor 320 and is configured to transmit and receive messages over a one or more networks, e.g., inter-server networks or public network 170. Additionally, the network interface unit 310 is configured to transmit and receive VM migration messages to facilitate the VM migration NAC process logic 400 according to the techniques described herein.

Processor 320 is coupled to the network interface unit 310 and to the memory 330. Processor 320 is a microprocessor or microcontroller that is, for example, configured to execute program logic instructions (i.e., software) for carrying out various operations and tasks described herein. For example, processor 320 is a processor circuit in any suitable platform or implementation form, e.g., in an application specific integrated circuit. For example, processor 320 is configured to execute VM migration NAC process logic 400 that is stored in memory 330 to enable a secure migration of VMs among various network appliances. Memory 330 may comprise read only memory (ROM), random access memory (RAM), magnetic disk storage media devices, optical storage media devices, flash memory devices, electrical, optical or other physical/tangible memory storage devices.

The functions of processor 320 may be implemented by logic encoded in one or more tangible computer (non-transitory) readable storage media (e.g., embedded logic such as an application specific integrated circuit (ASIC), digital signal processor (DSP) instructions, software that is executed by a processor, etc), wherein memory 330 stores data used for the operations described herein and stores software or processor executable instructions that are executed to carry out the operations described herein.

The VM migration NAC process logic 400 may take any of a variety of forms, so as to be encoded in one or more tangible computer readable memory media or storage device for execution, such as fixed logic or programmable logic (e.g., software/computer instructions executed by a processor) and the processor 320 may be an (ASIC) that comprises fixed digital logic, or a combination thereof. For example, the processor 320 may be embodied by digital logic gates in a fixed or programmable digital logic integrated circuit, which digital logic gates are configured to perform the VM migration NAC process logic 400. In general, the VM migration NAC process logic 400 may be embodied in one or more computer readable storage media encoded with software comprising computer executable instructions and when the software is executed operable to perform the operations described herein for the process logic 400.

Referring to FIGS. 4a and 4b, flowcharts that depict the VM migration NAC process logic 400 are now described. FIG. 4a describes the process logic 400 with respect to a network appliance, e.g., one of servers 135 or 160, configured to receive a VM, e.g., VM 20(5), that is targeted for migration from another network appliance, e.g., one of servers 135 or 160. FIG. 4b describes the process logic 400 with respect to the network appliance with the VM that is targeted for migration to the receiving network appliance. FIGS. 4a and 4b depict operations of the process logic 400 with respect to FIGS. 2a and 2b, when the sending server is, e.g., server 135(2), and the receiving server is, e.g., server 160(1).

At 410, a first device in a network, e.g., server 160(1), receives a request from a second device, e.g., server 135(2), requesting to migrate a virtual machine to the first device. At 415, a probe request is sent to the second device, the probe request being a request message that is configured to request information about the operating conditions of the virtual machine. At 420, a response to the request is received comprising information about the virtual machine's operating conditions.

When process logic 400 is implemented on both the sending server and the receiving server, the hypervisor, e.g., hypervisor 22(2) shown in FIGS. 2a and 2b, in the sending server can monitor traffic in and out of a virtual network entity (VM), and collect statistics about the VM's traffic. In addition, a network snooping application, e.g., TCPDUMP, can assist in determining which applications are executed by the target VM. The hypervisor is a “trusted” entity and can report on the traffic characteristics of the VM to be migrated, e.g., based on observed traffic, and can also determine the applications that are running, e.g., by deep packet inspection. The observed traffic patterns, volume, and processor load can be used as a factor in migration, e.g., to decide whether or not to migrate the VM to the receiving network/data center.

The hypervisor can assist determining if the observed traffic and services will be supported by the receiving network. For example, if the target VM has Stream Control Transmission Protocol (SCTP) services running and the receiving network does not support an SCTP based firewall, or if the target VM has native IPv6 traffic and the receiving network does not support native IPv6, then VM migration can not possibly occur. Furthermore, as part of the migration request 410, the hypervisor in a host network, e.g., data center 105, can provide authenticity of the validation of the VM, e.g., by “vouching” for the VM by way of the trusted relationship between host/enterprise service provider and the overflow provider. The hypervisor can also assist in ascertaining the OS version of the VM being migrated along with the patch levels of the various software packages installed as part of the VM.

At 425, a determination is made as to whether the information in the response complies with a network access control policy, and at 430, in response to determining that the information complies with the network access control policy, the virtual machine is permitted to migrate, and otherwise the virtual machine migration request is denied.

Prior to sending the probe request at 415, a trusted agent or validation application may be sent to the sending server and installed with the target VM. Installing the correct version of the trusted agent may be a precondition to VM migration. The receiving entity, e.g., server 160(1), can directly interact and query the trusted agent. The trusted agent can be downloaded on demand, e.g., using a predefined service on the target VM. Moreover, trusted agent validity may be authenticated using a challenge/response mechanism, e.g., by exchanging authenticated digital certificates. The trusted agent can detect the VM's installed root kits.

A VM “bill of health” may be delivered by the trusted agent that provides the VM's status, e.g., the VM may be authorized to migrate, migrate yet needs some non-critical patches, or denied migration until certain conditions are met. The trusted agent may work in conjunction with an Authorization, Authentication, and Accounting (AAA) server in the provider network, e.g., in a similar fashion to traditional host-based NAC solutions. The trusted agent input is just one factor in determining whether to permit or deny migration, e.g., in addition to hypervisor input. The receiving entity may cross check hypervisor inputs and trusted agent observations to determine an overall migration decision. A mismatch between hypervisor and trusted agent information may pause the migration until further checks are made.

Referring now to FIG. 4b, the VM migration NAC process logic 400 is described with respect to the network appliance, e.g., server 135(2), with the VM that is targeted for migration to the receiving network appliance. At 450, a request message is sent to a first device from a second device in the network, where the request message is configured request to migrate the VM to the first device. At 455, a probe message is received from the first device, the probe request message comprising information configured to request information about the VM's operating conditions. At 460, a response to the probe request is sent to the first device, the response comprising information about the virtual machine's operating conditions. At 465, a message is received at the second device from the first device, the message granting or denying the VM migration request. At 470, in response to receiving a grant message, the virtual machine is migrated to the first device, and at 475, in response to receiving a denial message, the virtual machine migration to the first device is denied or canceled.

The probe message referred to herein in connection with FIGS. 4a and 4b may comprise, for example, one or more of protocol stack probe request, an application probe request, a VM authentication request, and a traffic monitoring request. The probe message may be configured to query a hypervisor associated with the virtual machine about the virtual machine's operating conditions. A trusted agent software process may be sent to run in connection with the virtual machine to be migrated. The trusted agent may be configured to collect virtual machine health information comprising one or more of virtual machine OS version, OS patch versions, root-kit information, virtual machine traffic types, virtual machine traffic volume, and services used by the virtual machine. The trusted agent may be queried for health information for the virtual machine and the response may comprise the health information.

The trusted agent may be configured to repair any defects in the virtual machine that would otherwise prevent VM migration. The trusted agent may also be configured to install corrective operating system patches. The trusted agent itself may be configured with the NAC policy and configured to determine if the virtual machine is suitable for virtual machine migration. The trusted agent configured to work in connection with an AAA server to determine if the virtual machine is suitable for VM migration.

In sum, techniques are provided to apply a network access control policy to a virtual VM migration before allowing the VM to migrate from one server to another server. A first device in a network receives a message from a second device, the message comprising information configured to request a migration of a VM to the first device. A message is sent to the second device configured to request information about the operating conditions of the VM. A response to the request is received comprising information about operating conditions of the VM. A determination is made as to whether the information in the response complies with a network access control policy. In response to determining that the information complies with the network access control policy, the virtual machine is permitted to migrate, or otherwise the virtual machine migration request is denied.

Furthermore, techniques are provided herein for the reverse or return migration, as described above in connection with FIG. 4b. A second device in a network sends a request message to a first device requesting the migration of the VM to the first device. The second device receives a probe request message from the first device, the probe request message being configured to request information about the operating conditions of the VM. A response to the probe request message is sent comprising information about the VM's operating conditions. A message is received from the first device granting or denying the VM migration request. In response to receiving a grant message, the VM is migrated, and otherwise the VM migration to the first device is canceled.

All of the additional techniques applied in the forward or initial migration described herein can be used during the return migration process, e.g., protocol stack probe and application probe requests, receiving a trusted agent to run in connection with the virtual machine to be migrated that may be configured with the NAC policy to determine if the virtual machine is suitable for virtual machine migration.

In addition, the VM migration evaluation techniques described herein may be embodied in an apparatus, e.g., a server, and system, e.g., a plurality of servers, as well as in one or more computer readable storage media encoded with software comprising computer executable instructions and when the software is executed, it is operable to perform the techniques described herein.

It is to be understood that although the above examples are described with respect to private and public data centers, the techniques described herein may be applied between any two network appliances either in the same data center or between any two data centers or networks. Furthermore, although the techniques are described with respect to a single VM migration, multiple VMs may be migrated at the same time with each VM having the same or different destinations, e.g., when a physical server has to be taken off-line for repair. Furthermore, a VM may be temporarily brought down, taken offline, started for the first time, or instantiated. When the VM is brought back up from a down condition, brought back online from an offline condition, started, or instantiated, the VM migration NAC process logic may be applied or reapplied to the VM at that time.

The techniques described herein allow the receiving server to be assured of hosting a “well-behaved” VM that has not been compromised. Provider data centers can thereby provide and market higher data center security levels, while enterprise data centers can control network access according their prescribed security policies.

The above description is intended by way of example only.

What is claimed is:

1. A method comprising:
at a first device in a network, receiving a message from a second device comprising information configured to request a migration of a virtual machine to the first device;
sending a message to the second device comprising information configured to request information about the operating conditions of the virtual machine;
receiving a response to the request comprising information about operating conditions of the virtual machine;
determining whether the information in the response complies with a network access control policy; and
in response to determining that the information complies with the network access control policy, permitting the virtual machine to migrate, or otherwise denying the virtual machine migration request.

2. The method of claim 1, wherein sending comprises sending one or more of protocol stack probe request, an application probe request, an virtual machine authentication request, and a traffic monitoring request.

3. The method of claim 1, wherein sending comprises sending a trusted agent software process to run in connection with the virtual machine to be migrated.

4. The method of claim 3, wherein sending comprises sending the trusted agent configured to collect virtual machine health information comprising one or more of virtual machine operating system (OS) version, OS patch versions, root-kit information, virtual machine traffic types, virtual machine traffic volume, and services used by the virtual machine.

5. The method of claim 3, further comprising sending a query to the trusted agent for virtual machine health information, and wherein receiving a response comprises receiving the health information.

6. The method of claim 3, wherein sending comprises sending the trusted agent configured to repair any defects in the virtual machine that would otherwise prevent virtual machine migration.

7. The method of claim 6, wherein sending comprises sending the trusted agent configured to repair any defects in the virtual machine by installing corrective operating system patches.

8. The method of claim 3, wherein sending comprises sending the trusted agent configured with the network access control policy to determine if the virtual machine is suitable for virtual machine migration.

9. The method of claim 8, wherein sending comprises sending the trusted agent configured to work in connection with an authorization/authentication server to determine if the virtual machine is suitable for virtual machine migration.

10. The method of claim 1, wherein sending comprises sending the request configured to query a hypervisor associated with the virtual machine about the virtual machine's operating conditions.

11. The method of claim 1, further comprising applying the network access control policy to a virtual machine that is started, instantiated, brought back up from a down condition, or brought back online from an offline condition.

12. A method comprising:
sending a message to a first device from a second device, the message comprising information configured to request migration of a virtual machine to the first device;
receiving a request message from the first device comprising information configured to request information about the operating conditions of the virtual machine;
sending a response to the request message, the response comprising information about operating conditions of the virtual machine;
receiving a message from the first device comprising information configured to grant or deny the virtual machine migration request;
in response to receiving a grant message, migrating the virtual machine to the first device; and
in response to receiving a denial message, canceling migration of the virtual machine to the first device.

13. The method of claim 12, wherein receiving the request message comprises receiving one or more of a protocol stack probe request, an application probe request, a virtual machine authentication request, a traffic monitoring request, and a hypervisor query.

14. The method of claim 12, wherein receiving the request message comprises receiving a trusted agent software process to run in connection with the virtual machine to be migrated and that collects virtual machine health information comprising one or more of virtual machine operating system (OS) version, OS patch versions, root-kit information, virtual machine traffic types, virtual machine traffic volume, and services used by the virtual machine, and that repairs any defects in the virtual machine that would otherwise prevent virtual machine migration.

15. The method of claim 12, wherein receiving the request message comprises receiving a trusted agent software process configured with a network access control policy and configured to determine if the virtual machine is suitable for virtual machine migration.

16. An apparatus comprising:
one or more network interface units configured to interface with one or more network appliances; and
a processor coupled to the one or more network interface units and configured to:
receive a message from a network appliance comprising information configured to request a migration of a virtual machine;
send a message to the network appliance comprising information configured to request information about operating conditions of the virtual machine;
receive a response to the request comprising information about the virtual machine's operating conditions;
determine whether the information in the response complies with a network access control policy; and
in response to determining that the information complies with the network access control policy, permit the virtual machine to migrate otherwise deny the virtual machine migration request.

17. The apparatus of claim 16, wherein the processor is configured to send the message comprising one or more of a protocol stack probe request, an application probe request, an virtual machine authentication request, a traffic monitoring request, and a hypervisor query.

18. The apparatus of claim 16, wherein the processor is configured to send a trusted agent software process configured to run in connection with the virtual machine to be migrated and configured to collect virtual machine health information comprising one or more of virtual machine operating system (OS) version, OS patch versions, root-kit information, virtual machine traffic types, virtual machine traffic volume, and services used by the virtual machine.

19. The apparatus of claim 16, wherein the processor is configured to send a trusted agent software process configured to repair any defects in the virtual machine that would otherwise prevent virtual machine migration, and to work in connection with an authorization/authentication server to determine if the virtual machine is suitable for virtual machine migration.

20. The apparatus of claim 16, wherein the processor is configured to send a trusted agent software process configured with the network access control policy and configured to determine if the virtual machine is suitable for virtual machine migration.

21. One or more computer readable storage media storing instructions that, when executed by a processor, cause the processor to:
receive a message from a network appliance comprising information configured to request a migration of a virtual machine;
send a message to the network appliance comprising information configured to request information about the operating conditions of the virtual machine;
receive a response to the request comprising information about operating conditions of the virtual machine;
determine whether the information in the response complies with a network access control policy; and
in response to determining that the information complies with the network access control policy, permit the virtual machine to migrate otherwise deny the virtual machine migration request.

22. The computer readable storage media of claim 21, wherein the instructions operable to send comprise instructions operable to send the message comprising one or more of a protocol stack probe request, an application probe request, an virtual machine authentication request, a traffic monitoring request, and a hypervisor query.

23. The computer readable storage media of claim 21, wherein the instructions operable to send comprise instructions operable to send a trusted agent software process to run in connection with the virtual machine to be migrated and configured to collect virtual machine health information comprising one or more of virtual machine operating system (OS) version, OS patch versions, root-kit information, virtual machine traffic types, virtual machine traffic volume, and services used by the virtual machine.

24. The computer readable storage media of claim 21, wherein the instructions operable to send comprise instructions operable to send a trusted agent software process configured to repair any defects in the virtual machine that would otherwise prevent virtual machine migration, and to work in connection with an authorization/authentication server to determine if the virtual machine is suitable for virtual machine migration.

25. The computer readable storage media of claim 21, wherein the instructions operable to send comprise instructions operable to send a trusted agent software process configured with a network access control policy and configured to determine if the virtual machine is suitable for virtual machine migration.
